(19) United States
(12) Patent Application Publication
(10) Pub. No.: US 2002/0131262 A1
(43) Pub. Date: Sep. 19, 2002

(54) Surface mounted night light and socket assembly

(76) Inventor: James D. Amburgey, Pinckney, MI (US)

Correspondence Address: James M. Deimen, Suite 300, 320 N. Main Street, Ann Arbor, MI, 48104-1192, US

(21) Appl. No.: 10/145,220

(22) Filed: May 14, 2002

Related U.S. Application Data
(63) Continuation-in-part of application No. 09/697,551, filed on Oct. 26, 2000, now Pat. No. 6,386,725.
(60) Provisional application No. 60/162,073, filed on Oct. 28, 1999.

(51) Int. Cl. F21V 1/10

(52) U.S. Cl. 362/95; 362/276; 362/360; 362/282

(57) ABSTRACT

A new night light comprises a night light as a permanent part of a face plate assembly that fits on a standard electrical box for a double socket or light switch. The face plate has assembled to it a small light bulb socket for a low wattage bulb, an on-off switch and a standard three prong socket in the preferred embodiments. The wiring for the components is all preassembled thereby permitting the new night light to be installed by connecting the ground and hot leads to the respective three wires extending into the standard electrical box. A suitable shade to diminish glare and direct light extends from the face plate, as does the on-off switch. In an alternative version, a diode replaces the switch to provide a dimmer but longer lasting constantly on night light, and, in a second alternative version, a light sensor replaces the switch to provide automatic on and off for the night light.

This application claims the benefit of provisional patent application no. 60/162,073, filed Oct. 28, 1999, and application no. 09,697,551 filed Oct. 26, 2000.

### BACKGROUND OF THE INVENTION

The field of the invention pertains to electric lighting and, in particular, to small lights usually used to provide a dim low light in residential rooms such as bedrooms, bathrooms and hallways at night. Such lights are intended to provide sufficient light for a sleepy person to walk around the room without colliding with furniture or walk from room to room without striking walls or tripping and falling. The light, however, is normally shaded and of low wattage to minimize any disturbance to sleeping persons.

A wide variety of plug-in night lights have been available for many years for residential use. The devices are typically equipped with integral plugs to simply fit into standard wall sockets. While satisfactory for residential use, plug-in night lights are not satisfactory for commercial use such as in hotels, motels, cruise ships and other locations where sleeping space is temporarily rented to strangers for relatively short periods of time. The collision and tripping hazards are much greater with persons unfamiliar with their surroundings.

Further, in commercial settings plug-in night lights are subject to easy loss or theft and can be the source of a tripping hazard themselves. In view of the inadequacy of plug-in night lights, the applicant has developed the surface mounted night light disclosed below.

### SUMMARY OF THE INVENTION

The new night light comprises a night light as a permanent part of a face plate assembly that fits on a standard electrical box for a double socket or light switch. The face plate has assembled to it a small light bulb socket for a low wattage bulb, an on-off switch and a standard three-prong socket in the preferred embodiments. The wiring for the components is all pre-assembled thereby permitting the new night light to be installed by connecting the ground and hot leads to the respective three wires extending into the standard electrical box. A suitable shade to diminish glare and direct the light extends from the face plate as does the on-off switch.

In a first alternative version, a diode is inserted in place of the switch to provide a much lower but constant light level, less energy use and longer bulb life. Such a unit is useful in hotel bathrooms where it may be preferable to leave the light on constantly rather than rely upon an occupant to turn the night light on. The unit is also useful where there is already a wall switch for the room or a hallway.

In a second alternative version, a shaded electric eye is inserted in place of the switch to cause the night light to turn on automatically whenever outdoor light or room light is insufficient. Here again, such a unit is useful where it may be preferable to automatically turn the night light on rather than rely upon an occupant to turn the night light on.

### DESCRIPTION OF THE DRAWINGS

FIG. 1 is a front (face plate) view of the new light with a portion of the shade broken away;

FIG. 2 is a right side view of the new light with a portion of the shade broken away;

FIG. 3 is a top view of the new light;

FIG. 4 is a back view of the new light;

FIG. 5 is a schematic circuit for a diode controlled night light; and

FIG. 6 is a schematic circuit for a transistor and electric eye controlled night light.

### DESCRIPTION OF THE PREFERRED EMBODIMENT

In FIG. 1 an electrical box face plate 10 is shown having holes 12 for screws to fasten the face plate to a typical electrical box for a dual socket. The face plate 10 supports a three-prong socket 14, an on-off switch 16 and a small lamp assembly 18, all of which fit through holes in the face plate.

As shown in FIG. 2, two “hot” electrical wires and a ground wire 20 enter the socket 14. One hot wire or lead 15 connects to the switch 16, and another hot lead 17 connects to the lamp socket 22 of the lamp assembly 18. The switch 16 is further connected with a hot lead 19 to the lamp socket 22. Thus, operation of the switch 16 controls the lamp light.

The entire electrical assembly above described behind the face plate 10 fits within a standard electrical box 24. The lamp assembly 18 includes a translucent or opaque shade 26 and low wattage bulb 28 to create a dim but adequate amount of light when installed in an electrical box 24 near the floor. The lamp shade 26 may be formed with vents 30 as best shown in FIG. 3 to prevent overheating of the shade despite the low wattage of the bulb 28.

The switch 16 is located under the lamp assembly 18 purposely to require the switch be operated manually and prevent operation by foot. Since the night light is intended to be located near the floor, foot operation would likely be attempted by patrons in a hotel or motel setting. Thus, if the switch were located above or to the side of the light assembly 18, patrons would more than likely attempt to operate the switch by foot. A misplaced attempt would then result in damage to the shade 26 and bulb 28.

As an alternative, a shade mounted to the face plate on a horizontal pivot at 34 in FIG. 2 combined with a push button switch at 16, both of substantial construction, could operate the light with foot actuation. Such a night light would also require a horizontal cross-bar 36 on the shade 26 to actuate the switch and would result in substantially increased manufacturing cost.

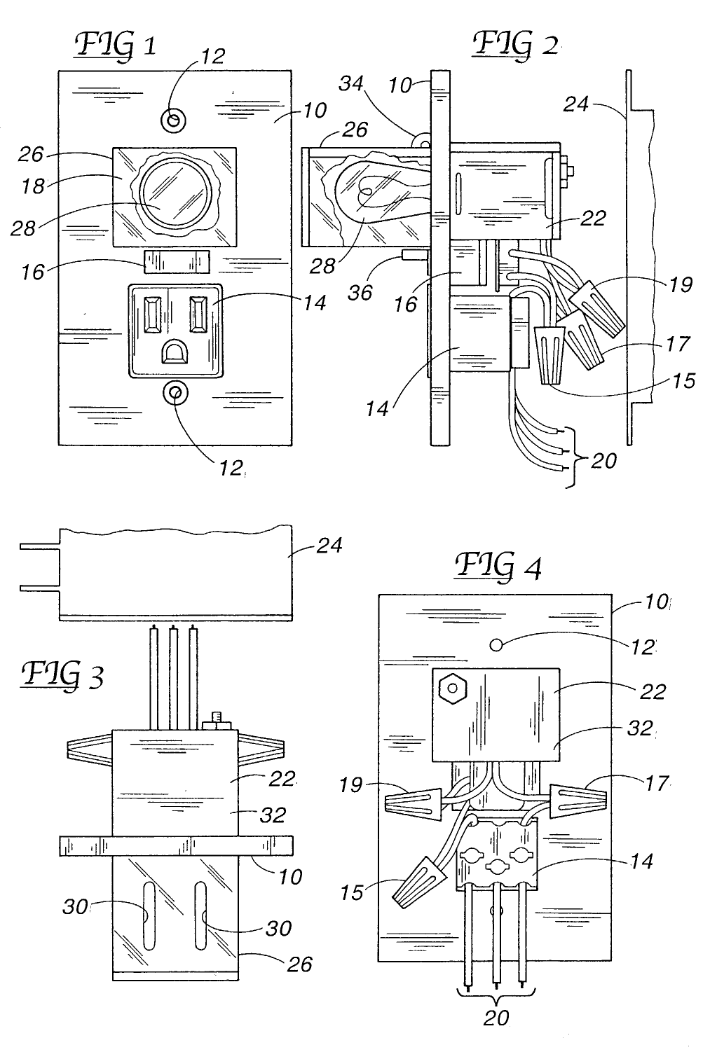

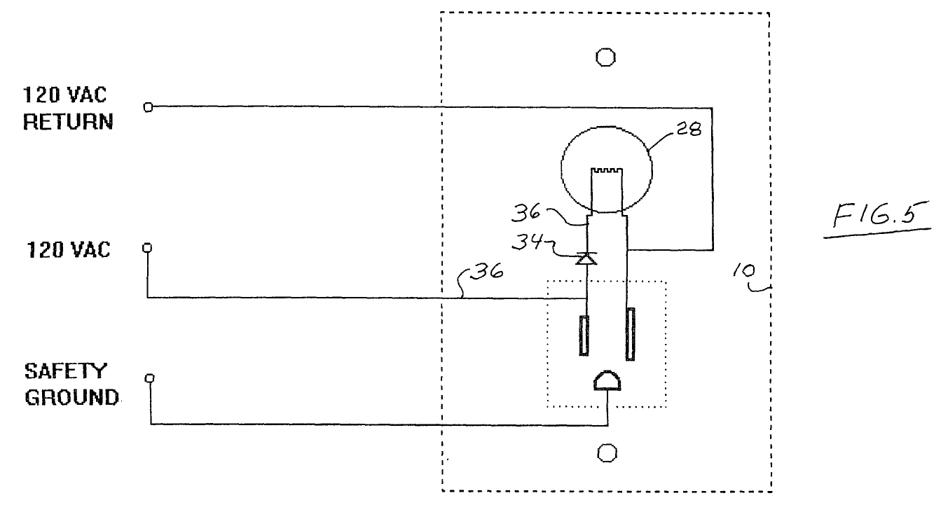

Referring to FIGS. 3 and 4, the lamp socket 22 as shown includes a protective box 32. As an alternative, the protective box may be enlarged to include the portion of the switch 16 behind the face plate 10 and the portion of the prong socket 14 behind the face plate. Thus, the entire assembly behind the face plate 10 may be protected during shipment and installation of the night light.

While generally intended for installation near the floor in motel and hotel rooms, the new night light may be mounted at counter height in a bathroom with inclusion of a ground fault interrupter circuit. Here again, the switch 16 is preferably located under the bulb 28 and shade 26 to discourage operation with an elbow, and the switch is non-red to avoid confusion with the ground fault interrupter switch or circuit breaker.

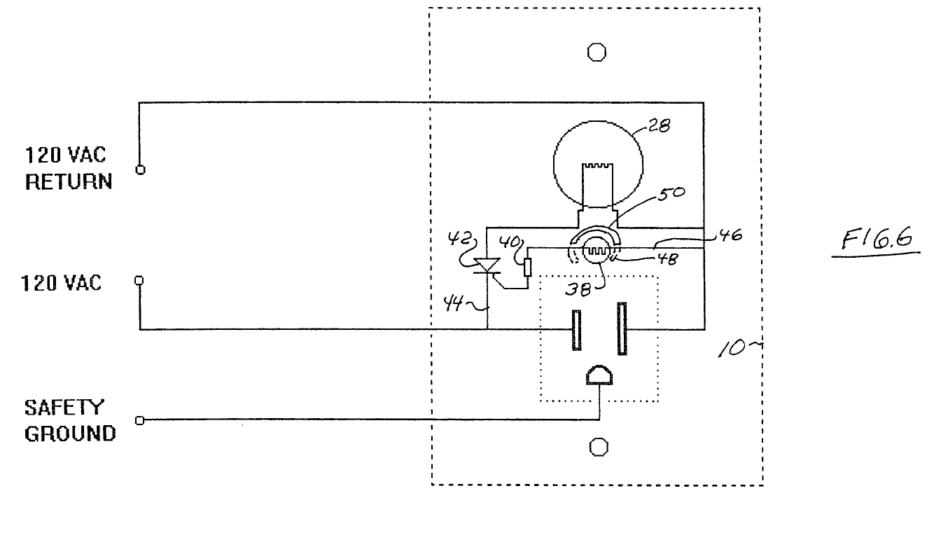

In FIG. 5, an alternative version of the night light, a diode 34 is inserted in the electric circuit 36 leading to the night light bulb 28. This circuit provides a constantly on bulb useful where the room or hallway requires a constant low light not dependent upon humans to turn on and off. This circuit is also useful where a wall switch for a socket is already, provided. Because the diode 34 cuts the electric energy delivered to the bulb 28 by about one-half, the bulb is dimmer and cooler, resulting in much longer life. Or a higher wattage bulb can be tolerated without damaging the shade 26.

In FIG. 6, the switch 16 is replaced by a light sensor 38 located below the bulb 28 and shade 26. The light sensor 38 through a resistor 40 controls a transistor 42 inserted in the circuit 44 leading to the bulb 28. The light sensor 38, located in a circuit 46 parallel to the circuit 44, automatically switches the night light on when ambient light dims sufficiently and switches the night light off when ambient light brightens sufficiently.

A three-quarter circular slot 48 is formed in the face plate 10, and a semi-cylindrical shade 50 is partially inserted into the three-quarter circular slot 48. The semi-cylindrical shade 50 extends outwardly from the face plate 10 a distance sufficient to prevent direct light from the bulb 28 from causing the light sensor 38 to hunt and the bulb to flicker.

1. An integral night light assembly comprises an electrical box face plate, a lamp socket mounted on the face plate and extending behind the face plate,
a bulb in the socket, said bulb extending in front of the socket and face plate,
a diode mounted behind the face plate and electrically connected to the lamp socket, and
a shade mounted above the bulb.

2. The integral night light assembly of claim 1 including a three-prong socket electrically connected to the lamp socket.

3. The integral night light assembly of claim 1 including vents in the shade.

4. An integral night light assembly comprises an electrical box face plate, a lamp socket mounted on the face plate and extending behind the face plate,
a bulb in the socket, said bulb extending in front of the socket and face plate,
a light sensor mounted in the face plate and exposed to the outside environment, said light sensor electrically connected to the lamp socket through a transistor,
a first shade mounted above the bulb, and a second shade interposed between the bulb and the sensor whereby the sensor is shielded from direct radiation from the bulb.

5. The integral night light assembly of claim 4 including a three-prong socket mounted on the face plate, said three-prong socket electrically connected to the lamp socket.

6. The integral night light assembly of claim 4 including vents in the first shade.

7. The integral night light assembly of claim 4 wherein the second shade can be rotated or extended to adjust the shade position relative to the bulb.
